(19) United States
(12) Patent Application Publication
(10) Pub. No.: US 2005/0240616 A1
(43) Pub. Date: Oct. 27, 2005

(54) Container-managed method support for container-managed entity beans

(75) Inventors: John William Alcorn, Heyworth, IL (US); Eric Nels Herness, Rochester, MN (US); Arthur Thomas Jolin, Chapel Hill, NC (US); Teresa Chung Kan, Rochester, MN (US); Kevin William Sutter, Rochester, MN (US)

Correspondence Address: Robert R. Williams;IBM Corporation, Dept. 917, 3605 Highway 52 North, Rochester, MN, 55901-7829, US

(73) Assignee: International Business Machines Corporation, Armonk, NY (US)

(21) Appl. No.: 10/829,625

(22) Filed: Apr. 22, 2004

(51) Int. Cl. G06F 17/00

(52) U.S. Cl. 707/102

(57) ABSTRACT

A method, apparatus, system, and signal-bearing medium that in an embodiment receive a specification of a method in a container-managed persistence bean and a specification of a procedure in a backend data store, generate code in a helper class associated with the container-managed persistence bean, determine a connector based on a connection factory type, and access the procedure via a backend-specific protocol and the connector. The code in the helper class performs the accessing. In this way, the container-managed persistence bean may access the backend data store without knowledge of the backend-specific protocol.

### FIELD

This invention generally relates to computer systems and more specifically relates to container-managed method support for container-managed entity beans.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware (such as semiconductors, integrated circuits, programmable logic devices, programmable gate arrays, and circuit boards) and software, also known as computer programs.

Software developers face the fundamental problem that writing an enterprise-wide application is difficult, and writing a distributed application is even more difficult. In addition, an enterprise seeks to build an application as fast as possible without being locked into one platform. Ideally, enterprise developers would like to be able to write the application once and run it on all of their platforms. Enterprise JavaBeans technology seeks to provide this ability.

The Enterprise JavaBeans (EJB) component architecture is designed to enable enterprises to build scalable, secure, multi-platform, business-critical applications as reusable, server-side components. Its purpose is to solve the enterprise problems by allowing the enterprise developer to focus only on writing business logic. The EJB specification creates an infrastructure that provides for the system-level programming, such as transactions, security, threading, naming, object-life cycle, resource pooling, remote access, and persistence. EJB also simplifies access to existing applications, and provides a uniform application development model for tool creation use using object-oriented programming techniques.

Object-oriented programming techniques involve the definition, creation, use, and instruction of “objects.” These objects are software entities comprising data elements or attributes and methods, which manipulate data elements. Objects also may include data related to events outside of the object to trigger or control methods within the object.

Java is an object-oriented programming language and environment focusing on defining data as objects and the methods that may be applied to those objects. Java supports only a single inheritance, meaning that each class can inherit from only one other class at any given time. Java also allows for the creation of totally abstract classes known as interfaces, which allow the defining of methods that may be shared with several classes without regard for how other classes are handling the methods.

The Java virtual machine (JVM) is a virtual computer component that resides in memory. In some cases, the JVM may be implemented in a processor. The JVM allows Java programs to be executed on a different platform as opposed to only the one platform for which the code was compiled. Java programs are compiled for the JVM. In this manner, Java is able to support applications for many types of data processing systems, which may contain a variety of central processing units and operating systems architectures.

To enable a Java application to execute on different types of data processing systems, a compiler typically generates an architecture-neutral file format—the compiled code is executable on many processors, given the presence of the Java run-time system. The Java compiler generates bytecode instructions that are non-specific to a particular computer architecture. These bytecodes are executed by a Java interpreter. A Java interpreter is a module in the JVM that alternately decodes and executes a bytecode or bytecodes.

A Java bean is a reusable component. Various programs in Java may be created by aggregating different Java beans. An entity bean represents a business object in a persistent storage mechanism. Some examples of business objects are customers, orders, and products. In the J2EE (Java 2 Platform Enterprise Edition) SDK (Software Development Kit), the persistent storage mechanism can be a relational database, or any non-relational data store, such as a CICS (Customer Information Control System) file system. In case of a relational database, each entity bean has an underlying table in a relational database, and each instance of the bean corresponds to a row in that table.

Entity beans differ from session beans in several ways. Entity beans are persistent, allow shared access, have primary keys, and may participate in relationships with other entity beans. Because the state of an entity bean is saved in a storage mechanism, it is persistent. Persistence means that the entity bean's state exists beyond the lifetime of the application or the J2EE server process. The data in a database is persistent because it still exists even if the database server or the applications it services are powered off.

There are two types of persistence for entity beans: bean-managed and container-managed. With bean-managed persistence, the entity bean code contains the calls that access the datastore. If a bean has container-managed persistence, the EJB container automatically generates the necessary datastore access calls. The code for the entity bean does not include these calls.

Entity beans may be shared by multiple clients. Because the clients might want to change the same data, it's important that entity beans work within transactions. Typically, the EJB container provides transaction management. In this case, the bean's deployment descriptor specifies the transaction attributes. Transaction boundaries are not coded in the bean because the container marks the boundaries.

Like a table in a relational database, an entity bean may be related to other entity beans. For example, in a college enrollment application, StudentEJB and CourseEJB would be related because students enroll in classes.

Developers implement relationships differently for entity beans with bean-managed persistence and those with container-managed persistence. With bean-managed persistence, the developer-written code implements the relationships. But, with container-managed persistence, the EJB container takes care of the relationships for the developer. For this reason, relationships in entity beans with container-managed persistence are often referred to as container-managed relationships.

The term container-managed persistence means that the EJB container handles all database access required by the entity bean. The bean's code contains no database access calls. As a result, the bean's code is not tied to a specific persistent storage mechanism (database). Because of this flexibility, even if the developer redeploys the same entity bean on different J2EE servers that use different databases, modifying or recompiling the bean's code is not necessary. In short, container-managed persistent entity beans are more portable.

The EJB specification defines a set of CMP accessor methods that are handled by the EJB container to process the persistent access. These accessor methods include the CRUD methods, such as create, read, update, and delete. The accessor methods are generated by the deployment tool to access the database via the JDBC code.

Besides being much easier to develop and offering greater portability, container-managed persistent beans have additional benefits over bean-managed persistent beans, such as query, caching, and connection pooling. Also, container-managed persistent beans enable greater configuration and administration options, allowing dynamic control over access intent and connectivity parameters.

The EJB specification defines the concept of a deployment descriptor, which is stored in XML (Extensible Markup Language), which essentially contains information used during deployment of the bean to an application server. It also defines multiple roles involved in the process of creating and deploying an EJB-based application, including the bean developer, the application assembler, and the deployer. The bean developer is the one who actually writes the Java code for the EJB. The application assembler is the one who fills out the deployment descriptor, helping map the general purpose bean to a specific use, such as the specifics for the persistence of the bean, such as describing the mapping of a CMP (container-managed persistence) bean to a table in a particular database vendor's database. The deployer is the one who uses the information from the deployment descriptor to generate the necessary artifacts to run the bean on a specific application server.

There are two types of deployment descriptors: generic and vendor-specific extensions. The generic one (named ejb-jar.xml), whose schema is defined by the EJB specification, and which all application server vendors must support, contains basic structural information about the bean, such as a list of the container-managed persistence fields and the key class for a given container-managed persistence bean. The deployment descriptor extensions, which are specific to a given application server vendor, contain specialized deployment information not formalized or required by the EJB specification, such as settings used by a value-added proprietary service implemented by a specific vendor. As the EJB specification evolves from version to version, the contents of the generic EJB deployment descriptor continue to expand, as vendors bring forward some of their extensions for standardization as part of upcoming versions of the EJB specification, via the Java Community Process (JCP).

While some new applications are currently being developed using the emerging technologies of container-managed persistent beans, the EJB specification, the J2EE programming model, and web programming, other applications may have been developed many years ago using the legacy technology of procedural programming. Although the development trend is to move away from the procedural applications and replace them with the emerging technology applications, the legacy procedural applications have been fully tested and executing for perhaps decades, so many users are reluctant to replace them. This is because users perceive the replacing of the procedural applications (which are stable and known to work) with an emerging technology to potentially be expensive, time-consuming, and frustrating. Thus, both emerging and legacy applications often coexist in one complex application environment.

The EJB 2.0 specification allows accessing backend data without knowing the backend resource manager. It provides container-managed persistence (CMP), which allows the plugging in of any backend resource manager without changing the application and the entity beans. Unfortunately, EJB does not provide a means for an EJB bean to access the existing, legacy, procedures or applications. In other words, the enterprise application and entity bean developers must manually provide some bean-managed logic in the bean's business methods in order to utilize these legacy applications, which complicates the container-managed persistence bean development. In addition, no way exists for the container-managed persistence bean developer to inform the development tool to generate the appropriate code to use these legacy procedures. Further, the EJB specification does not describe how to get the actual data for container-managed persistence entity beans. Current implementations afford only access to relational data using container-managed persistence. Non-relational access must be done through bean-managed persistence. This, then, keeps the advantages of container-managed persistence from being enjoyed by those accessing non-relational, legacy, applications.

Without a better way for accessing legacy applications, users will be unable to take full advantage of the benefits of container-managed persistence.

### SUMMARY

A method, apparatus, system, and signal-bearing medium are provided that in an embodiment receive a specification of a method in a container-managed persistence bean and a specification of a procedure in a backend data store, generate code in a helper class associated with the container-managed persistence bean, determine a connector based on a connection factory type, and access the procedure via a backend-specific protocol and the connector. The code in the helper class performs the accessing. In this way, the container-managed persistence bean may access the backend data store without knowledge of the backend-specific protocol.

### BRIEF DESCRIPTION OF THE DRAWINGS

FIG. 1 depicts a block diagram of an example system for implementing an embodiment of the invention.

FIG. 2 depicts a block diagram of selected components of the example system, according to an embodiment of the invention.

FIG. 3 depicts a flowchart of example processing for a deployment tool, according to an embodiment of the invention.

### DETAILED DESCRIPTION

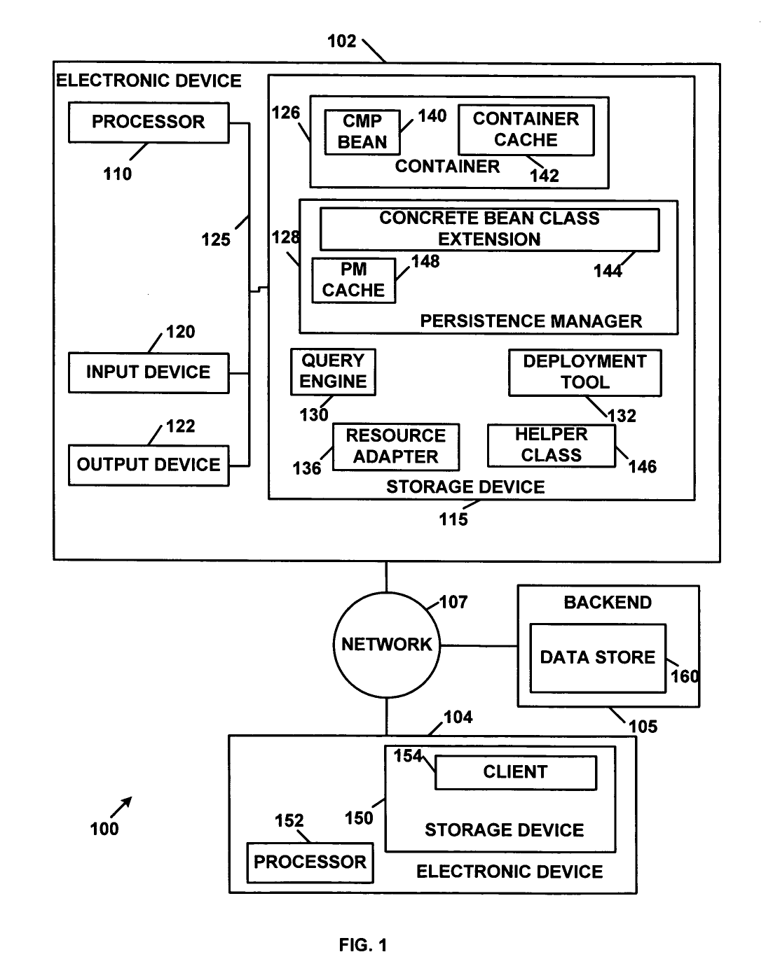

FIG. 1 depicts a block diagram of an example system 100 for implementing an embodiment of the invention. The system 100 includes electronic devices 102 and 104 connected to a backend device 105 via a network 107. Although only one electronic device 102, one electronic device 104, one backend 105, and one network 107 are shown, in other embodiments any number or combination of them may be present.

The electronic device 102 includes a processor 110, a storage device 115, an input device 120, and an output device 122, all connected directly or indirectly via a bus 125. The processor 110 represents a central processing unit of any type of architecture, such as a CISC (Complex Instruction Set Computing), RISC (Reduced Instruction Set Computing), VLIW (Very Long Instruction Word), or a hybrid architecture, although in other embodiments any appropriate processor may be used. The processor 110 executes instructions and includes that portion of the electronic device 102 that controls the operation of the entire electronic device. Although not depicted in FIG. 1, the processor 110 typically includes a control unit that organizes data and program storage in memory and transfers data and other information between the various parts of the electronic device 102. The processor 110 reads and/or writes code and data to/from the storage device 115, the network 107, the input device 120, and/or the output device 122.

Although the electronic device 102 is shown to contain only a single processor 110 and a single bus 125, embodiments of the present invention apply equally to servers that may have multiple processors and multiple buses with some or all performing different functions in different ways. In an embodiment, the hardware of the electronic device 102 may be implemented via a Websphere Application Server available from International Business Machines, Inc. But, in other embodiments any appropriate electronic device may be used.

The storage device 115 represents one or more mechanisms for storing data. For example, the storage device 115 may include read only memory (ROM), random access memory (RAM), magnetic disk storage media, optical storage media, flash memory devices, and/or other machine-readable media. In other embodiments, any appropriate type of storage device may be used. Although only one storage device 115 is shown, multiple storage devices and multiple types of storage devices may be present. Further, although the electronic device 102 is drawn to contain the storage device 115, it may be distributed across other electronic devices, such as devices connected to the network 107.

The storage device 115 includes a container 126, a persistence manager 128, a query engine 130, a deployment tool 132, a resource adapter 136, and a helper class 146, all of which in various embodiments may have any number of instances. The container 126 includes a container-managed persistence (CMP) bean 140, and a container cache 142. The container 126 caches the container-managed persistence bean 140 in the container cache 142.

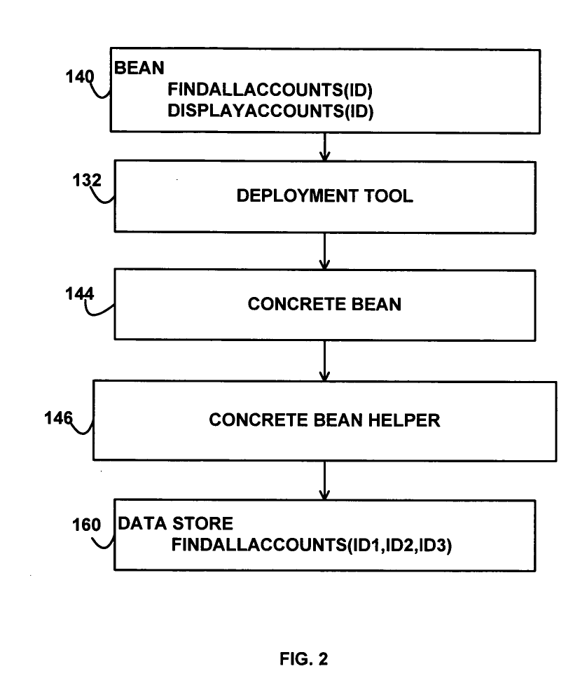

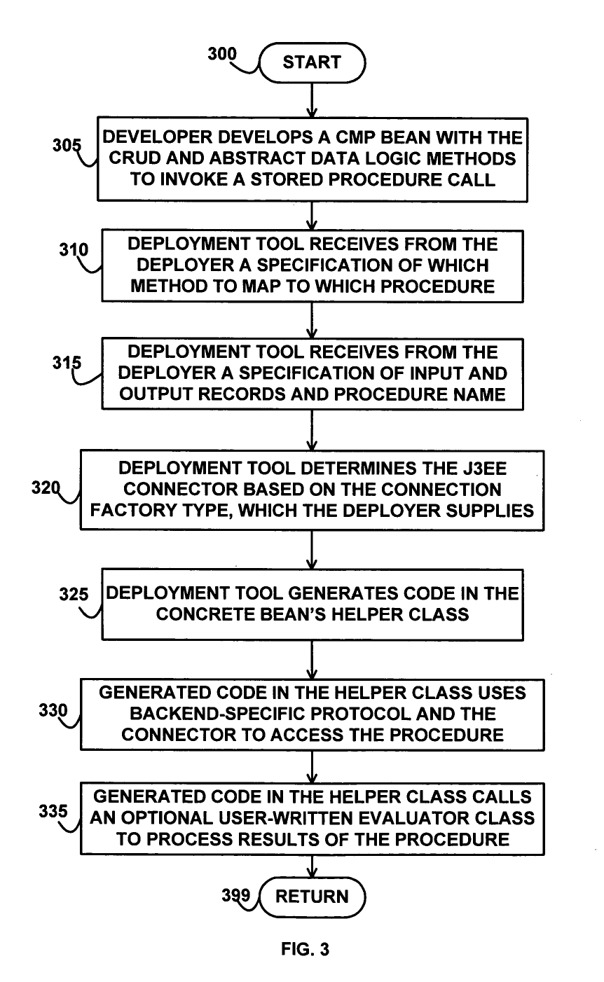

The persistence manager 128 includes a concrete bean class extension 144 and a persistence manager cache 148. The deployment tool 132 generates the helper class 146, which is used by the resource adapter 136 to send the request to the backend store 105. The query engine 130 reads the CMP bean's deployment descriptor to convert the EJB into an appropriate backend query that is used as the input to the code generation process of the deployment tool 132. The deployment tool 132 includes instructions capable of executing on the processor 110 or statements capable of being interpreted by instructions executing on the processor 110 to carry out the functions as further described below with reference to FIGS. 2 and 3.

The input device 120 may be a keyboard, mouse or other pointing device, trackball, touchpad, touchscreen, keypad, microphone, voice recognition device, or any other appropriate mechanism for the user to input data to the electronic device 102 and/or to manipulate the user interfaces, if any, of the electronic device 102. Although only one input device 120 is shown, in another embodiment any number, including zero, and type of input devices may be present.

The output device 122 is that part of the electronic device 102 that presents output to the user. The output device 122 may be a cathode-ray tube (CRT) based video display well known in the art of computer hardware. But, in other embodiments the output device 122 may be replaced with a liquid crystal display (LCD) based or gas, plasma-based, flat-panel display. In still other embodiments, any appropriate display device may be used. In other embodiments, a speaker or a printer may be used. In other embodiments any appropriate output device may be used. Although only one output device 122 is shown, in other embodiments, any number of output devices of different types or of the same type may be present. In another embodiment, the output device 122 is not present.

The bus 125 may represent one or more busses, e.g., PCI (Peripheral Component Interconnect), ISA (Industry Standard Architecture), X-Bus, EISA (Extended Industry Standard Architecture), or any other appropriate bus and/or bridge (also called a bus controller).

The electronic device 102 may be implemented using any suitable hardware and/or software. Examples of electronic devices are personal computers, portable computers, laptop or notebook computers, PDAs (Personal Digital Assistants), pocket computers, telephones, pagers, automobiles, teleconferencing systems, appliances, midrange computers, and mainframe computers, but in other embodiments any appropriate electronic device may be used. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted.

The electronic device 104 may be an electronic device implemented via any suitable hardware and/or software that sends requests to and receives responses from the electronic device 102 via the network 107. The electronic device 104 may include a storage device 150 and a processor 152 analogous to those already described above with reference to the electronic device 102. The electronic device 104 may further contain other components in various embodiments, such as an unillustrated input device, a bus, or any other appropriate components. The storage device 150 includes a client 154. The client 140 performs transactions and sends associated requests to the server electronic device 102 to accomplish the transactions. The server electronic device 102 accesses data in the data store 160 of the backend 105 in response to the requests from the client 154.

The backend 105 includes a data store 160. In an embodiment, the data store 160 may be a relational database or database management system that stores data in tables, i.e., rows and columns of data, and performs searches by using data in a specified column or columns of one table to find additional data in another table. The rows of a table represent records (collections of information about separate items) and the columns represent fields (particular attributes about the separate items). When performing the search, the relational database matches information from a field in one table with information in a corresponding field of another table to produce a third table that combines request data from both tables. Examples of relational databases are DB2 (Database 2), and Oracle9i, although in other embodiments any appropriate relational store may be used.

In another embodiment, the data store 160 may be a non-relational database. In contrast to the relational database, in a non-relational database, only one file can be used at a time. Unlike relational databases, there is no common language or API for communicating with non-relational data stores, making interaction with them proprietary and difficult, especially for developers skilled primarily in J2EE (Java 2 Platform Enterprise Edition). Examples of non-relational stores are IMS (Information Management System), CICS (Customer Information Control System), and a flat file (a one or two-dimensional array, a list, or a file that has no hierarchical structure), but in other embodiments any appropriate non-relational store may be used.

The network 107 may be any suitable network or combination of networks and may support any appropriate protocol suitable for communication of data and/or code to/from the electronic device 102, the electronic device 104, and the backend 105. In various embodiments, the network 107 may represent a storage device or a combination of storage devices. In an embodiment, the network 107 may support Infiniband. In another embodiment, the network 107 may support wireless communications. In another embodiment, the network 107 may support hard-wired communications, such as a telephone line or cable. In another embodiment, the network 107 may support the Ethernet IEEE (Institute of Electrical and Electronics Engineers) 802.3× specification. In another embodiment, the network 107 may be the Internet and may support IP (Internet Protocol). In another embodiment, the network 107 may be a local area network (LAN) or a wide area network (WAN). In another embodiment, the network 107 may be a hotspot service provider network. In another embodiment, the network 107 may be an intranet. In another embodiment, the network 107 may be a GPRS (General Packet Radio Service) network. In another embodiment, the network 107 may be any appropriate cellular data network or cell-based radio network technology. In another embodiment, the network 107 may be an IEEE 802.11B wireless network. In still another embodiment, the network 107 may be any suitable network or combination of networks. Although one network 107 is shown, in other embodiments any number of networks (of the same or different types) may be present.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the electronic device 102, and that, when read and executed by one or more processors in the electronic device 102, cause the electronic device 102 to perform the steps necessary to execute steps or elements embodying the various aspects of an embodiment of the invention.

Moreover, while embodiments of the invention have and hereinafter will be described in the context of fully functioning electronic devices, the various embodiments of the invention are capable of being distributed as a program product in a variety of forms, and the invention applies equally regardless of the particular type of signal-bearing medium used to actually carry out the distribution. The programs defining the functions of this embodiment may be delivered to the electronic device 102 via a variety of signal-bearing media, which include, but are not limited to:
(1) information permanently stored on a non-rewriteable storage medium, e.g., a read-only memory device attached to or within a server, such as a CD-ROM readable by a CD-ROM drive;
(2) alterable information stored on a rewriteable storage medium, e.g., a hard disk drive or diskette; or
(3) information conveyed to a server by a communications medium, such as through a computer or a telephone network, e.g., the network 107, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of selected components of the example system 100, according to an embodiment o the invention. Embodiments of the invention allow the development of container-managed persistence entity beans 140 that can access any procedure (existing or newly created) from any backend data store 160 without knowing details of the backend data store 160. The concrete bean 144 implements an abstract method on the bean interface. The deployment tool 132 generates accessor methods, through which container-managed persistent fields are accessed. The implementation of the accessor methods may delegate the invocation of backend procedures to the concrete bean helper class 146 to perform an operation. The helper class 146 hides the implementation details of how to access the data to the backend store 160 from the bean 140. In various embodiments, the accessor method in the helper class 146 may use, e.g., a JDBC (Java Database Connectivity) driver or any other appropriate type of driver to access relational data in the data store 160, or may use some other mechanism to access non-relational data in the data store 160.

The deployment tool 132 facilitates the mapping between the container-managed methods of the bean 140, which includes the accessor methods or business methods in a CMP bean, and the legacy procedures of the data store 160. When a method is selected to map to a procedure, the user provides binding information. The binding information includes the procedure name, the procedure input and output parameters, the connection factory name and type, and the business method evaluator class to evaluate/process the results of the procedure.

The deployment tool 132 uses the binding information to generate code in the concrete bean's helper class 146. Based on the connection factory type, the helper class 146 determines what kind of connector is being used. The helper class 146 then uses a protocol specific to the data store 160 of the backend 105 to access the procedure.

In the example shown in FIG. 2, the legacy procedure in the data store 160 is a SQL stored procedure named “findAllAccounts,” which takes three input account identifier parameters (ID1, ID2, ID3) and returns three results sets, each containing corresponding data. The container-managed persistent bean 140 wants to take advantage of this existing procedure in the data store 160. The container-managed persistent bean 140 defines an abstract method “findAllAccounts(ids[ ])” to return a collection of objects. This abstract method is implemented in the bean's concrete bean 144, which delegates the call to the concrete beans helper class 146 to invoke the SQL stored procedure in the data store 160. The user-written evaluator class is called to perform any processing of the results prior to the helper class 146 closing the connection to the backend 105. In addition, the container-managed persistent bean 140 may have another business method that uses this returned collection objects to display data (“displayAccounts(id)”) by calling the findAllAccounts method. The same mechanism also applies to any non-relational procedures. The methods and procedures illustrated in FIG. 2 are exemplary only, and in other embodiments any appropriate methods and procedures may be used.

FIG. 3 depicts a flowchart of example processing for the deployment tool 132, according to an embodiment of the invention. Control begins at block 300. Control then continues to block 305 where the developer develops the container-managed persistence bean 140 with the CRUD (Create, Read, Update, Delete) and other abstract data logic (business) methods to invoke a stored procedure call in the data store 160. Control then continues to block 310 where the deployment tool 132 receives from the deployer a specification of which method in the container-managed persistence bean 140 to map to which procedure in the data store 160. In various embodiments, the method may be an EJB accessor method or any data logic method. Control then continues to block 315 where the deployment tool 132 receives from the deployer a specification of input and output records and the procedure name. Control then continues to block 320 where the deployment tool 132 determines the J2EE connector, or any other appropriate type of connector, based on the connection factory type, which the deployer supplies. Control then continues to block 325 where the deployment tool 132 generates code in the concrete bean's helper class 146. Control then continues to block 330 where the generated code in the helper class 146 uses a back-end specific protocol to access the procedure in the data store 160, mapping the input and output records between the method and the procedure. Control then continues to block 335 where the generated code in the helper class 146 calls an optional user-written evaluator class and passes the results of the procedure in the data store 160. The evaluator class evaluates results of the procedure. Control then continues to block 399 where the logic of FIG. 3 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

1. A method comprising:
receiving a specification of a method in a container-managed persistence bean and a procedure in a backend data store; and
accessing the procedure via a backend-specific protocol.

2. The method of claim 1, further comprising:
generating code in a helper class associated with the container-managed persistence bean.

3. The method of claim 2, wherein the code in the helper class performs the accessing.

4. The method of claim 1, further comprising:
receiving a specification of input and output records for the procedure; and
mapping the input and output records between the method and the procedure.

5. The method of claim 1, further comprising:
determining a connector based on a connection factory type; and
accessing the procedure via the connector.

6. An apparatus comprising:
means for receiving a specification of a method in a container-managed persistence bean and a procedure in a backend data store;
means for generating code in a helper class associated with the container-managed persistence bean; and
means for accessing the procedure via a backend-specific protocol.

7. The apparatus of claim 6, wherein the code in the helper class performs the means for accessing.

8. The apparatus of claim 6, further comprising:
means for receiving a specification of input and output records for the procedure; and
means for mapping the input and output records between the method and the procedure.

9. The apparatus of claim 6, further comprising:
means for determining a connector based on a connection factory type; and
means for accessing the procedure via the connector.

10. The apparatus of claim 6, further comprising:
means for calling an evaluator class and passing results of the procedure, wherein the evaluator class evaluates the results.

11. A signal-bearing medium encoded with instructions, wherein the instructions when executed comprise:
receiving a specification of a method in a container-managed persistence bean and a procedure in a backend data store;
generating code in a helper class associated with the container-managed persistence bean; and
accessing the procedure via a backend-specific protocol, wherein the code in the helper class performs the accessing.

12. The signal-bearing medium of claim 11, further comprising:
receiving a specification of input and output records for the procedure; and
mapping the input and output records between the method and the procedure.

13. The signal-bearing medium of claim 11, further comprising:
determining a connector based on a connection factory type; and
accessing the procedure via the connector.

14. The signal-bearing medium of claim 11, further comprising:
calling an evaluator class and passing results of the procedure, wherein the evaluator class evaluates the results.

15. The signal-bearing medium of claim 11, wherein the backend data store comprises a relational database.

16. A computer system comprising:
a processor; and
a storage device encoded with instructions, wherein the instructions when executed on the processor comprise:
receiving a specification of a method in a container-managed persistence bean and a procedure in a backend data store,
generating code in a helper class associated with the container-managed persistence bean,
determining a connector based on a connection factory type, and
accessing the procedure via a backend-specific protocol and the connector, wherein the code in the helper class performs the accessing.

17. The computer system of claim 16, wherein the instructions further comprise:
receiving a specification of input and output records for the procedure; and
mapping the input and output records between the method and the procedure.

18. The computer system of claim 16, wherein the instructions further comprise:
calling an evaluator class and passing results of the procedure, wherein the evaluator class evaluates the results.

19. The computer system of claim 16, wherein the backend data store comprises a relational database.

20. The computer system of claim 16, wherein the backend data store comprises a non-relational database.
